(19) United States
(12) Patent Application Publication
(10) Pub. No.: US 2009/0057600 A1
(43) Pub. Date: Mar. 5, 2009

(54) Vacuum opening/closing valve

(75) Inventors: Masayuki Watanabe, Kasugai-shi (JP); Makoto Miyahara, Komaki-shi (JP); Shunsuke Umezawa, Kasugai-shi (JP)

Correspondence Address: OLIFF & BERRIDGE, PLC, P.O. BOX 320850, ALEXANDRIA, VA, 22320-4850, US

(73) Assignee: CKD CORPORATION, Komaki-shi (JP)

(21) Appl. No.: 12/222,101

(22) Filed: Aug. 1, 2008

(30) Foreign Application Priority Data
Aug. 29, 2007 (JP) 2007-222096
May 14, 2008 (JP) 2008-126832

(51) Int. Cl. F16K 31/126

(52) U.S. Cl. 251/335.2

(57) ABSTRACT

A durable vacuum opening/closing valve connectable with a vacuum chamber and a vacuum pump is arranged to control vacuum pressure in the vacuum chamber by changing an opening degree of an O ring serving as a valve element relative to a valve seat. A predetermined clearance between an outer peripheral surface of a piston and an inner peripheral surface of a cylinder is sealed by a bellofram which changes its shape in association with movement of the piston moved to open or close the valve. The bellofram includes an inclined surface with a predetermined inclination angle and the outer periphery of the piston includes an inclined surface with a predetermined inclination angle, so that an inner diameter of the bellofram in contact with the piston and the outer diameter of the piston are equal when the valve element is in contact with the valve seat.

### FIELD OF THE INVENTION

The present invention relates to a vacuum opening/closing valve. Specifically, the vacuum opening/closing valve connectable between a vacuum container and a vacuum pump for controlling vacuum pressure of a gas in the vacuum container by changing a valve opening degree.

### DESCRIPTION OF THE RELATED ART

Heretofore, for example, in a semiconductor manufacturing process, such a vacuum pressure controlling system has been proposed that a process gas and a purge gas are alternately charged in and discharged from a vacuum chamber in which a wafer is placed. In this vacuum pressure controlling system, a vacuum opening/closing valve is placed connectable between the vacuum chamber and a vacuum pump. The vacuum opening/closing valve is arranged to change its opening degree to control vacuum pressure of the process gas which will be supplied into the vacuum chamber (see Japanese Unexamined Patent Publication No. 09(1997)-072458).

A conventional vacuum opening/closing valve will be explained referring to FIGS. 11 to 16. FIG. 11 is a sectional view of a vacuum opening/closing valve 100 arranged in a vacuum pressure controlling system disclosed in JP09-072458A. FIG. 12 is an enlarged view of a part R in FIG. 11 showing a bellofram 150 in a valve closed state. FIG. 13 is a sectional view of the conventional bellofram 150. FIG. 14 is an explanatory view showing a texture of a base cloth 151B of the bellofram 150.

In the vacuum opening/closing valve 100, driving air is supplied into an air chamber AS to move a piston 140 upward (in FIG. 11), and accordingly a poppet valve element 176 connected to the piston 140 through a piston rod 147 is moved upward in a stroke direction of the piston 140, so that the poppet valve element 176 is separated from a valve seat 173, opening a valve. The piston 140 is movable inside a single-acting pneumatic cylinder 130 (hereinafter, “cylinder 130”) but out of contact with the cylinder 130 for preventing a stick-slip. A clearance 145 between the piston 140 and the cylinder 130 is hermetically sealed by the bellofram 150 which is movable in accordance with motion of the piston 140. Thereby, the air chamber AS can ensure its air tightness.

The bellofram 150 is, as shown in FIG. 13, of a trapezoidal shape in section when seen from a bore (or radial) direction of the piston 140. The bellofram 150 is formed of rubber in which a base cloth 151B such as polyester is embedded by insert molding. As shown in FIG. 14, a texture of the base cloth 151B is formed with warp threads and weft threads woven in plain weave by passing each warp thread over and under each weft thread in grid pattern. The bellofram 150 includes a center portion 152 fixed to a pressure receiving surface 142 of the piston 140, and a flange portion 153 fixed by a flange holding portion 132 of the cylinder 130. In the bellofram 150, a circumferential single-tapered surface 154, which is deeply folded back from the flange portion 153 toward the center portion 152 is a single inclined surface with a single taper angle θp making with an imaginary line N in parallel with an axis AX.

In addition, the conventional bellofram 150 is designed trapezoidal because of the following reasons.

(a) In the vacuum opening/closing valve 100 provided with the bellofram 150, an outer diameter dp of an outer peripheral surface of the piston 140 is smaller than an inner diameter of the cylinder 130 by the predetermined clearance 145, and the single-tapered surface 154 of the bellofram 150 is stretchable to a top dead center of the piston 140 in accordance with the motion of the piston 140.

(b) In the vacuum opening/closing valve 100, in the valve closed state, the center portion 152 and the flange portion 153 of the bellofram 150 are placed on almost the same level. As shown in FIGS. 11 and 12, the single-tapered surface 154 is folded inside in mountain-folded shape the clearance 145 between the piston 140 and the cylinder 130.

This is because the single-tapered surface 154 is formed as the single inclined surface with the predetermined single taper angle θp with respect to the axis AX, namely, the imaginary line N, so that the bellofram 150 can be easily extended and contracted in association with opening/closing action of the vacuum opening/closing valve 100.

Additionally, a vacuum opening/closing valve operated by use of a bellofram is disclosed in FIG. 1 of Japanese Unexamined Patent Application Publication No. 2002-132354 and FIGS. 2, 5, and 6 of Japanese Unexamined Patent Application Publication No. 07(1995)-150623. Further, a technique that a bellofram is provided with inclined surfaces with different angles is disclosed in FIGS. 1 and 4 of Japanese Unexamined Patent Application Publication No. 56(1981)-049462, FIG. 3 of Japanese Unexamined Utility Model Application Publication No. 61(1986)-140296, and FIGS. 2 and 5 of Japanese Unexamined Utility Model Application Publication No. 61(1986)-172230.

Furthermore, it is disclosed that a bellofram is made by insert molding of rubber around a tricot-woven base cloth in Japanese Unexamined Patent Application Publication No. 10(1998)-317262 and Japanese Unexamined Patent Application Publication No. 10(1998)-132077.

However, the above-mentioned vacuum opening/closing valve 100 has the following problems.

(1) FIGS. 11 and 12 show a closed state of the vacuum opening/closing valve 100. In this state, when the driving air is supplied to the air chamber AS, pressurizing force of the driving air is applied to the center portion 152 of the bellofram 150 and the single-tapered surface 154 folded back inside the clearance 145 between the piston 140 and the single-acting pneumatic cylinder 130, thereby moving the piston 140 upward.

Accordingly, the single-tapered surface 154 changes its shape from the mountain folded shape in FIG. 12 to another shape partially swelling out toward both the outer peripheral surface of the piston 140 and the inner surface of the cylinder 130 due to the driving air supplied to the air chamber AS (see FIG. 15).

The bellofram 150 of a trapezoidal shape is provided with the single-tapered surface 154 located outside the outer peripheral surface of the piston 140 relative to the axial direction AX. In a certain position in the axis direction AX, the tapered surface of the bellofram 150 that contacts with the piston 140 has a tapered surface diameter Dp larger than the outer diameter dp of the piston 140 as indicated with a chain double-dashed line in FIG. 16. While the bellofram 150 includes the tapered surface, the piston 140 is of a cylindrical shape. Therefore, the shortest diameter of the bellofram 150 has to be determined in accordance with the diameter of the piston 140, resulting in a large difference between πDp and πdp at a position indicated in FIG. 12.

In other words, a circumferential length (perimeter of the single-tapered surface) πDp of the single-tapered surface 154 is longer than a circumferential length (outer perimeter of the piston) πdp on the outer peripheral surface of the piston 140. Consequently, a part of the bellofram 150 which is out of contact with the outer peripheral surface of the piston 140 is liable to form a wrinkled portion 159.

As a difference between the perimeter of the single-tapered surface πDp and the outer perimeter of the piston πdp becomes larger, the wrinkled portion 159 becomes larger. Further, the pressurizing force applied to the outer peripheral surface of the piston 140 along the single-tapered surface 154 of the bellofram 150 is larger than pressure in an inner space of the wrinkled portion 159 between the single-tapered surface 154 and the outer peripheral surface of the piston 140.

Consequently, when the pressurizing force is applied to the wrinkled portion 159 along the single-tapered surface 154, some parts of the single-tapered surface 154 are pressed so as to be in contact with or closer to each other, and extend radially outwardly from the outer peripheral surface of the piston 140. Accordingly, each extended part is largely folded at a bent portion 159B located on an outermost side in the radial direction. When the single-tapered surface 154 is partially extended radially outwardly, the part of the single-tapered surface 154 having the bent portion 159B of the wrinkled portion 159 tends to be folded acutely, possibly causing excessive bending stress on the bent portion 159B.

In a state that the bent portion 159B is generated as shown in FIG. 16, when the piston 140 in FIG. 15 is moved upward, the bent portion 159B changes from a side contacting with the piston 140 to a side contacting with an inner wall of the cylinder 130. In other words, the bent portion 159B turns its orientation 180 degrees (in the radial direction). At the side contacting with the inner wall of the cylinder 130, the bent portion 159B becomes smoothed because the diameter of the inner wall is large enough to stretch the bent portion 159B. However, when the bent portion 159B is turned 180 degrees, stress is concentrated on the bent portion 159B. Every time the vacuum opening/closing valve is operated, the stress concentration is repeated, causing vertical cracks in the bellofram 150.

While the applicant has provided the above-mentioned vacuum opening/closing valves all over the world, the applicant has had difficulty in finding a cause of a problem relating to durability of the bellofram 150. Finally, the applicant has now succeeded in identifying the cause by repeated experiments as mentioned above.

(2) Secondly, since the base cloth of the bellofram 150 is formed with plain-woven texture as shown in FIG. 14, the bellofram 150 has less flexibility and is hard to be bent freely. Therefore, the wrinkled portion 159 locally exists as a comparably large wrinkle on a periphery of the single-tapered surface 154 when the driving air is supplied (see FIG. 16). Subsequently, during a valve closing, parts of the base cloth of the single-tapered surface 154, which is mountain-folded at the wrinkled portion 159, rub against each other. This may cause a crack generated in a top portion (fold) 158 to grow larger to reach the wrinkled portion 159 over time, thus tearing or breaking the base cloth of the bellofram 150.

Due to the problems mentioned in (1) and (2), there is a possibility that the driving air supplied into the air chamber AS could leak through the bellofram 150, failing to control the valve opening degree of the vacuum opening/closing valve 100. As a result, the bellofram 150 has to be replaced quite often and more durable vacuum opening/closing valve is demanded.

### SUMMARY OF THE INVENTION

The present invention has been made in view of the above circumstances and has an object to overcome the above problems and provide a durable vacuum opening/closing valve wherein a clearance between an outer peripheral surface of a piston and an inner peripheral surface of a cylinder is hermetically sealed by a bellofram which is movable in accordance with movement of the piston, and the piston is moved by fluid to open or close the vacuum opening/closing valve.

(1) To achieve the purpose of the present invention, there is provided a vacuum opening/closing valve connectable between a vacuum container and a vacuum pump. The valve comprises a valve seat formed with a port connectable with one of the vacuum container and the vacuum pump, a valve element movable into and out of contact with the valve seat, a piston movable by fluid to move the valve element, a cylinder in which the piston is housed, and a bellofram placed to hermetically seal a predetermined clearance between an outer peripheral surface of the piston and an inner peripheral surface of the cylinder and to change shape in association with movement of the piston. The vacuum opening/closing valve is arranged to control vacuum pressure in the vacuum container by changing an opening degree of the valve element with respect to the valve seat. In the vacuum open/close valve, the bellofram includes a peripheral surface formed with a predetermined inclination angle and arranged to contact with the outer peripheral surface of the piston, the outer peripheral surface of the piston includes an inclined surface formed with a predetermined inclination angle, the bellofram and the piston are designed so that an inner diameter of the peripheral surface of the bellofram at a portion contacting with the piston and an outer diameter of the piston contacting the peripheral surface of the bellofram are equal when the, valve element is in contact with the valve seat, the inclination angle of the bellofram and the inclination angle of the piston are equal, the peripheral surface of the bellofram comprises first and second inclined surfaces having different inclination angles with respect to an axis along a stroke direction of the piston in section along a central axis of the bellofram, and the inclination angle of the bellofram is a smaller one of the inclination angles of the first and second inclination surfaces. The vacuum opening/closing valve further comprises a rod connecting the valve element and the piston, in which the bellofram further includes a through hole through which the rod extends, and the bellofram is fitted on an outer periphery of the rod through the through hole and positioned in place.

(2) In the above vacuum opening/closing valve (1), preferably, the bellofram comprises a fixing portion at a radial peripheral edge with which the bellofram is fixed to the cylinder and further comprises a curved portion that connects the first and second inclined surfaces, the curved portion being positioned closer to the fixing portion than a center portion of the bellofram in a direction of the axis.

(3) In the above vacuum opening/closing valve (1), preferably, the bellofram is made of a rubber molded member formed of a base cloth insert-molded with rubber, and the base cloth is flexible woven texture along a surface of the bellofram.

(4) In the above vacuum opening/closing valve (3), preferably, the texture of the base cloth is tricot weave.

The vacuum opening/closing valve according to (1) is connectable between a vacuum chamber and a vacuum pump for controlling vacuum pressure in the vacuum chamber by changing an opening degree of a valve element relative to a valve seat. The vacuum opening/closing valve is also arranged such that a predetermined clearance between an outer peripheral surface of a piston and an inner peripheral surface of a cylinder is hermetically sealed by a bellofram which is moved in accordance with movement of the piston which is moved by fluid to open or close the valve. An inner peripheral surface of the bellofram contacting with the piston is angled at a predetermined inclination angle and the outer peripheral surface of the piston is angled at a predetermined inclination angle. While the valve element is in contact with the valve seat, the inner peripheral diameter of the bellofram contacting with the piston is equal to the outer peripheral diameter of the piston. Consequently, in a state that the vacuum opening/closing valve is closed, when driving air is supplied into the cylinder to apply air pressure on the bellofram, the inner diameter of the bellofram and the outer diameter of the piston are equal, so that the bellofram will not be bent or wrinkled.

Conventionally, the piston has a straight cylindrical shape. Therefore, the inner diameter of the bellofram that contacts with end face of the piston had to be larger than the outer diameter of the piston. In the present embodiment, the outer periphery of the piston includes a tapered surface, so that the inner diameter of the bellofram and the outer diameter of the piston in the valve closed state can be determined to be equal to each other.

Further, in the vacuum opening/closing valve according to (1), the taper angle of the bellofram is equal to the taper angle of the piston. Therefore, even when the piston is moved by a certain distance, the inner diameter of the bellofram is equal to the outer diameter of the piston and thus the bellofram is unlikely to be bent or wrinkled. The applicant has experimentally confirmed that even if the taper angle of the bellofram is slightly larger than the taper angle of the piston, durability of the bellofram can be outstandingly enhanced as long as the inner diameter of the bellofram and the outer diameter of the piston are equal when the valve element is in contact with the valve seat. The applicant has also experimentally learned that the durability can be further enhanced if the taper angle of the bellofram and the taper angle of the piston are determined to be equal.

In the vacuum opening/closing valve according to (1), the bellofram is formed with at least two tapered surfaces different in inclination angle from each other relative to an axis in a stroke direction of the piston when seen in section from a bore direction of the piston. When the bellofram is formed with two tapered surfaces, for example, a first taper angle θ1 is determined larger than a single-taper angle θp of the conventional bellofram (θp<θ1), hence a second taper angle θ2 can be smaller than the single-taper angle θp (θ2<θp).

In this case, the bellofram is designed such that the first tapered surface with the first taper angle θ1 relative to the axis is located closer to an inner peripheral surface of the cylinder and the second tapered surface with the second taper angle θ2 relative to the axis is located closer to an outer peripheral surface of the piston. Accordingly, the taper angle of the second tapered surface of the bellofram can be equal to a taper angle of an outer peripheral surface of the piston.

Consequently, the bellofram is formed with at least two tapered surfaces different in inclination angle to each other, so that the bellofram can be kept stretchable in accordance with opening/closing movement of the vacuum opening/closing valve. The bellofram can furthermore be prevented from short-term damages due to cracks resulting from wrinkles of the bellofram.

In the vacuum opening/closing valve according to (1), the bellofram is fitted on an outer periphery of the rod connecting the piston with the valve element and also the bellofram is formed with a through hole for positioning the bellofram.

Consequently, the bellofram can be accurately positioned relative to the piston through the rod.

For opening or closing the vacuum opening/closing valve, the tapered surface is moved and stretched to a top dead center or a bottom dead center in associated with movement of the piston. At this time, the tapered surface is mountain-folded near a center position in the stroke direction.

In the vacuum opening/closing valve according to (2), a curved portion connecting each of the tapered surfaces is placed closer to a fixing portion than the center portion of the bellofram along the axis direction. Consequently, the tapered surface of the bellofram will be mountain-folded but not folded at the curved portion.

Even when the vacuum opening/closing valve is repeatedly opened and closed, the tapered surface is not folded at the curved portion at which stress concentration is more likely to occur than at other portions of the tapered surfaces of the bellofram. Therefore, the bellofram can be prevented from deterioration (material fatigue of the material constituting the bellofram) caused by repetitive folding of the tapered surface at the curved portion.

As a result, the bellofram can be prevented from any damages at an earlier stage.

Further, in the vacuum opening/closing valve according to (3), the bellofram is made of a rubber molded member comprising a rubber and a base cloth which has a texture flexible along a surface of the bellofram. The rubber molded member is formed in a manner that the base cloth is insert-molded with the rubber.

Thus, the bellofram can obtain air tightness by the rubber and strength against the pressurizing force of the fluid by the base cloth. Concurrently, the bellofram can be freely bent along the shape of the outer peripheral surface of the piston in association with the movement of the piston.

In the vacuum opening/closing valve of the present invention according to (4), the base cloth of the bellofram is tricot weave, so that the bellofram is easy to be bent in accordance with the movement or the outer peripheral shape of the piston while the pressurizing force is applied by the fluid.

Especially, the bellofram is easy to be bent with aligning itself with the outer peripheral surface of the piston when the tapered surface of the bellofram swells out along the outer peripheral surface of the piston while the pressurizing force is applied by the fluid.

Thereby, in the vacuum opening/closing valve of the present invention, the tapered surface of the bellofram are wrinkled because of a gap between the perimeter of the tapered surface and the perimeter of the outer peripheral surface of the piston at a certain point of the piston in the stroke direction, but the gap can be smaller compared to the bellofram in the conventional vacuum opening/closing valve. Further, the wrinkles are kept smaller and scattered over the tapered surface unlike the comparably large wrinkles locally existing on the single-tapered surface of the bellofram of the conventional opening/closing valve. Therefore, while the vacuum opening/closing valve is opened or closed, any contact between each of the mountain-folded tapered surfaces at the wrinkled portion is avoidable, thereby each base cloth being prevented from rubbing against each other.

As a result, even if any cracks are generated on a mountain-folded portion in the tapered surface, it is preventable that the bellofram gets damaged due to friction of base cloths of the mountain-folded tapered surfaces, friction caused by enlarged cracks.

In addition, a tricot weave is, for example, similar to ribbed weave forming a ridge-like pattern having mountain parts and valley parts alternately continuing in a predetermined direction, knitting weave, and the like. Such technique including tricot weave can provide flexible, elastic, and stretchable fabric.

Furthermore, in the above-mentioned vacuum opening/closing valve, the bellofram includes a radial center portion formed with a protrusion protruding outward in a thickness direction of the bellofram, and the piston includes a pressure receiving surface along a bore direction formed with a recess. The bellofram and the piston are coaxially positioned and fixed by engagement of the protrusion and the recess.

Therefore, the radial center portion of the bellofram can be prevented from relative misalignment with respect to the pressure receiving surface of the piston. Consequently, the tapered surface of the bellofram can be equally bent or extended in the circumferential direction of the tapered surface in association with the movement of the piston, so that the piston can be moved appropriately.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a sectional view of a bellofram arranged in a vacuum opening/closing valve in a present embodiment;

FIG. 2 is an explanatory enlarged view of a part X in FIG. 1, showing a rubber molded member constituting the bellofram;

FIG. 3 is an explanatory view showing a texture of a base cloth of the bellofram;

FIG. 4 is an explanatory view showing a structure of the vacuum opening/closing valve in a valve closed state;

FIG. 5 is an explanatory view showing a structure of the vacuum opening/closing valve in a valve opened state;

FIG. 6 is an enlarged view of a part P shown in FIG. 4;

FIG. 7 is an explanatory enlarged view of a part Q in FIG. 6, showing a clearance between an outer peripheral surface of a piston and an inner peripheral surface of a cylinder;

FIG. 8 is a sectional view of the piston;

FIG. 9 is an explanatory sectional view taken along a line A-A in FIG. 6, showing the bellofram under pressure;

FIG. 10 is an explanatory view showing a configuration of a vacuum pressure controlling system including the vacuum opening/closing valve in the present embodiment;

FIG. 11 is an explanatory view showing a structure of a conventional vacuum opening/closing valve;

FIG. 12 is an enlarged view of a part R in FIG. 11;

FIG. 13 is a sectional view of a conventional bellofram;

FIG. 14 is an explanatory view showing a texture of a base cloth of the conventional bellofram;

FIG. 15 is a sectional view of the conventional bellofram under pressure; and

FIG. 16 is a sectional view taken along a line B-B in FIG. 15.

### DETAILED DESCRIPTION OF THE PREFERRED EMBODIMENTS

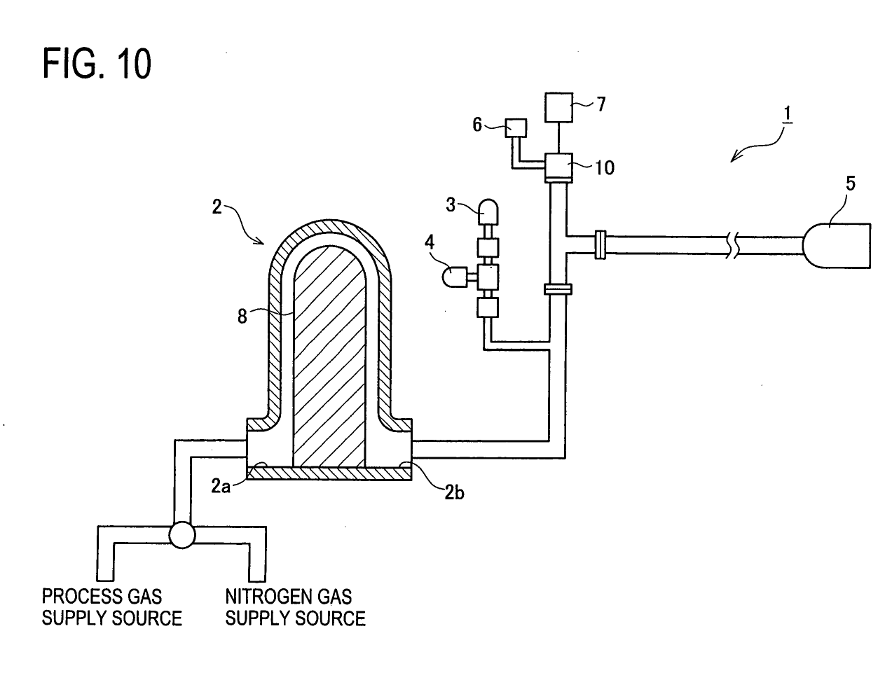

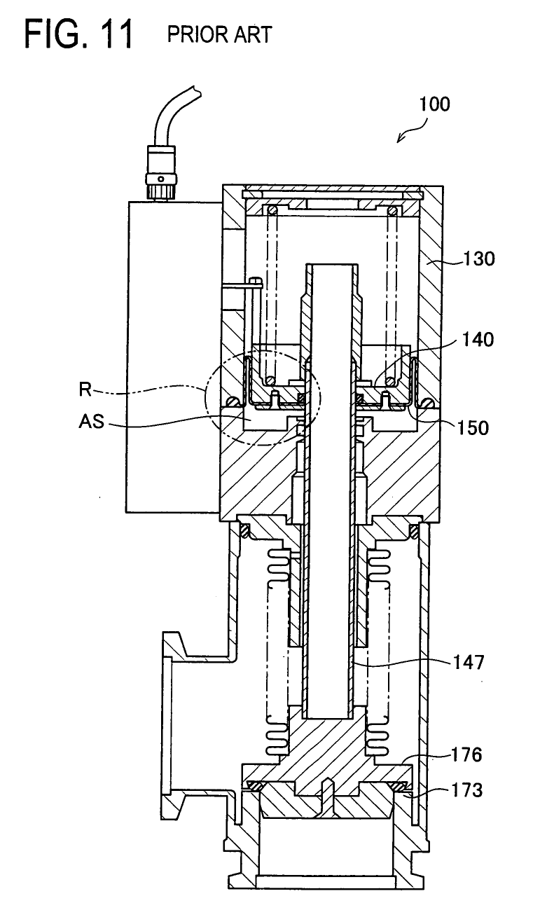

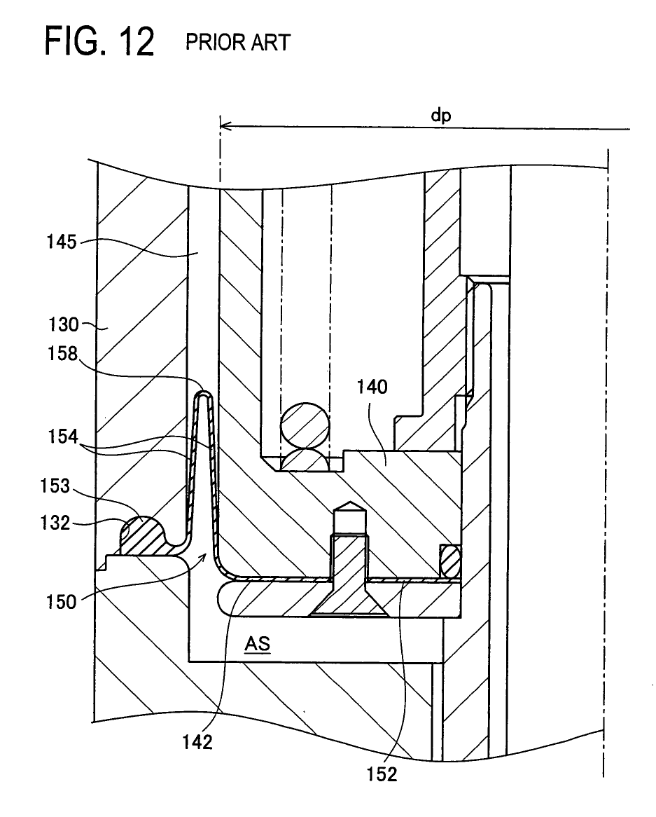

A detailed description of a preferred embodiment of a vacuum opening/closing valve embodying the present invention will now be given to the accompanying drawings. FIG. 10 is an explanatory view showing a configuration of a vacuum pressure controlling system 1 including a vacuum opening/closing valve 10.

The vacuum pressure controlling system 1 is a system for a surface treatment of a wafer 8 in a semiconductor manufacturing process by charging or discharging a process gas and a purge gas alternately into or out of a vacuum chamber 2 where the wafer 8 is placed. As shown in FIG. 10, the vacuum pressure controlling system 1 mainly includes the vacuum chamber 2 (a vacuum container), a vacuum pump 5, an air supply source 6 for supplying driving air AR, the vacuum opening/closing valve 10, a servo valve (unshown) for controlling a valve opening degree of the vacuum opening/closing valve 10, and a vacuum pressure controller 7 which is electrically connected to the vacuum opening/closing valve 10 and others.

A gas supply port 2a of the vacuum chamber 2 is connected in parallel with a process gas supply source and a nitrogen gas supply source. The process gas is used for the surface treatment of the wafer 8 provided in the vacuum chamber 2 and the nitrogen gas is used for purging the process gas from the vacuum chamber 2.

On the other hand, a gas exhaust port 2b of the vacuum chamber 2 is connected in parallel with the vacuum opening/closing valve 10 and a pressure sensor 3 for the chamber through a shutoff valve 4. The pressure sensor 3 is electrically connected with the vacuum pressure controller 7 to measure vacuum pressure of the process gas or the like in the vacuum chamber 2. Further, the vacuum opening/closing valve 10 is connected with the vacuum pump 5.

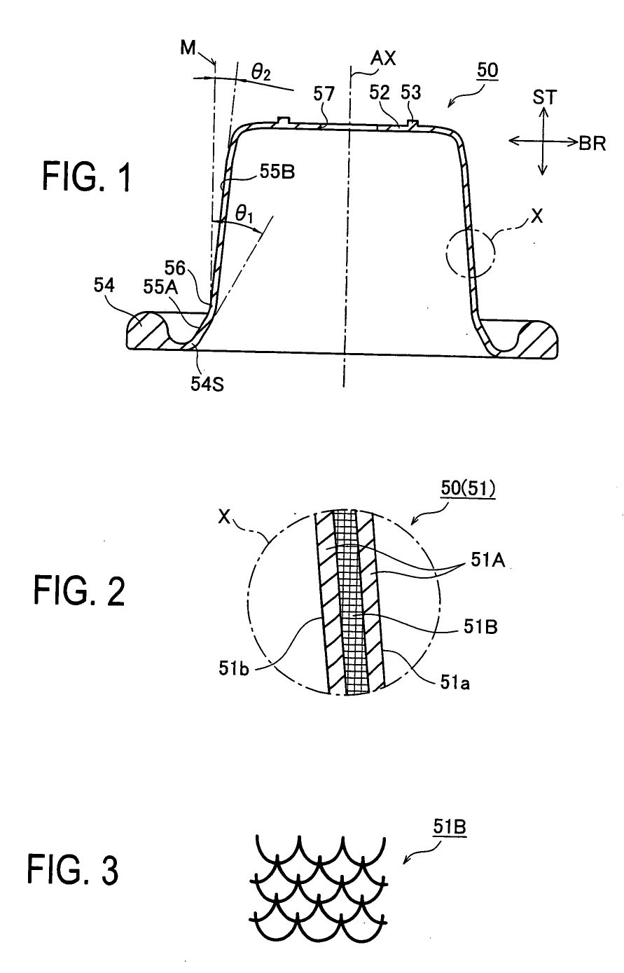

The vacuum opening/closing valve 10 is now explained referring to FIGS. 1 to 6.

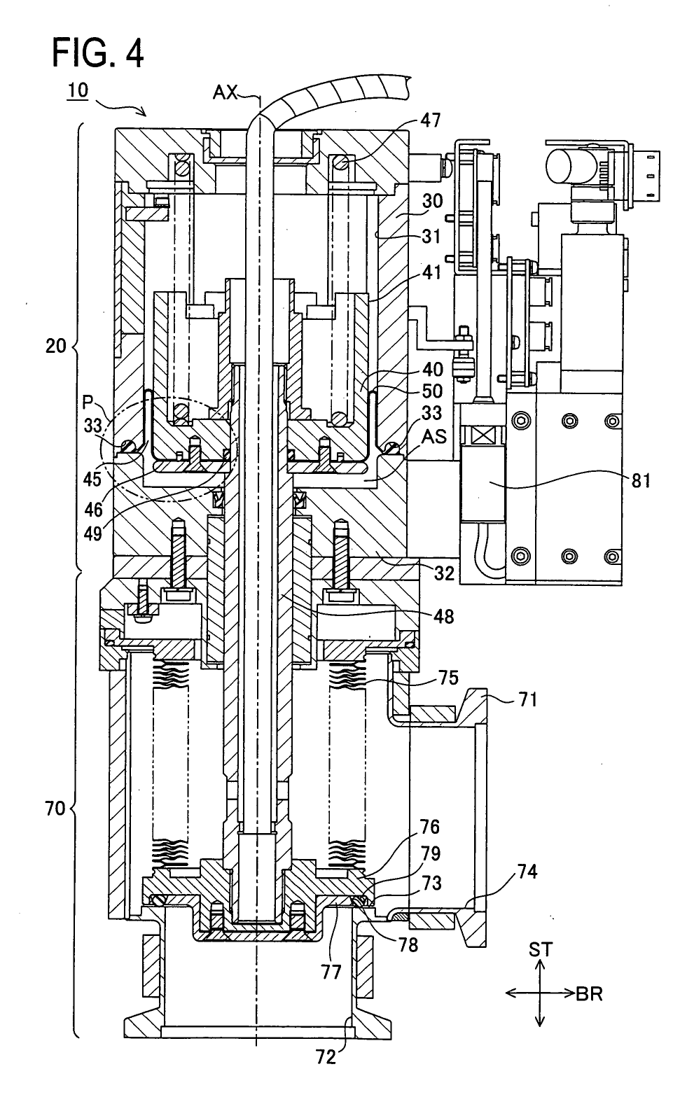

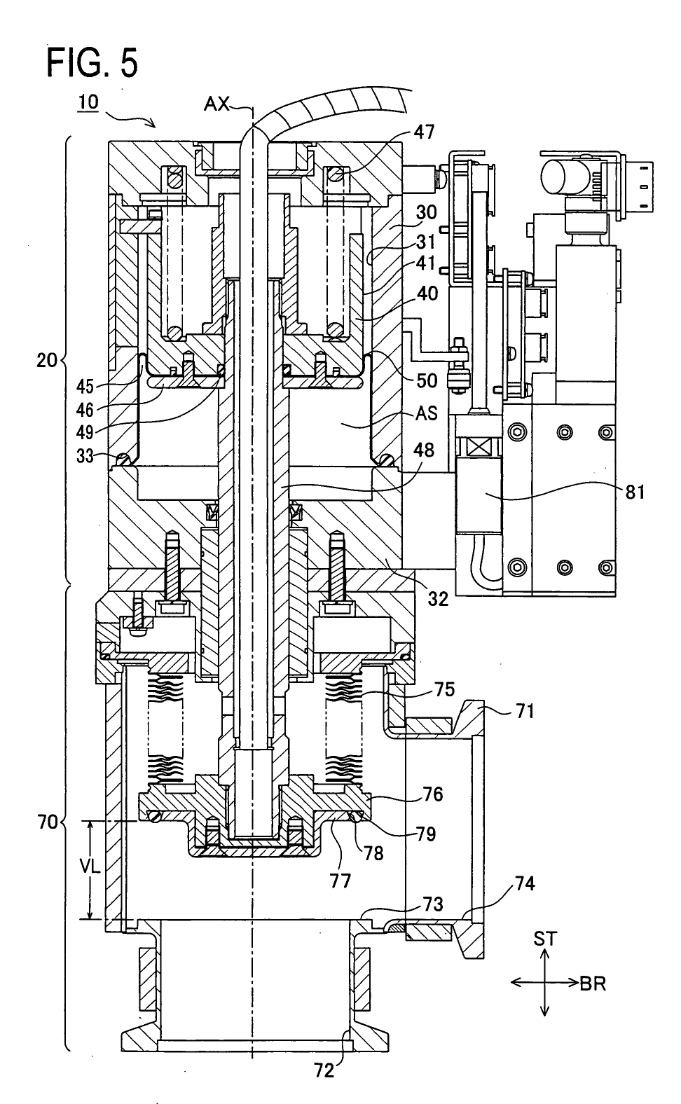

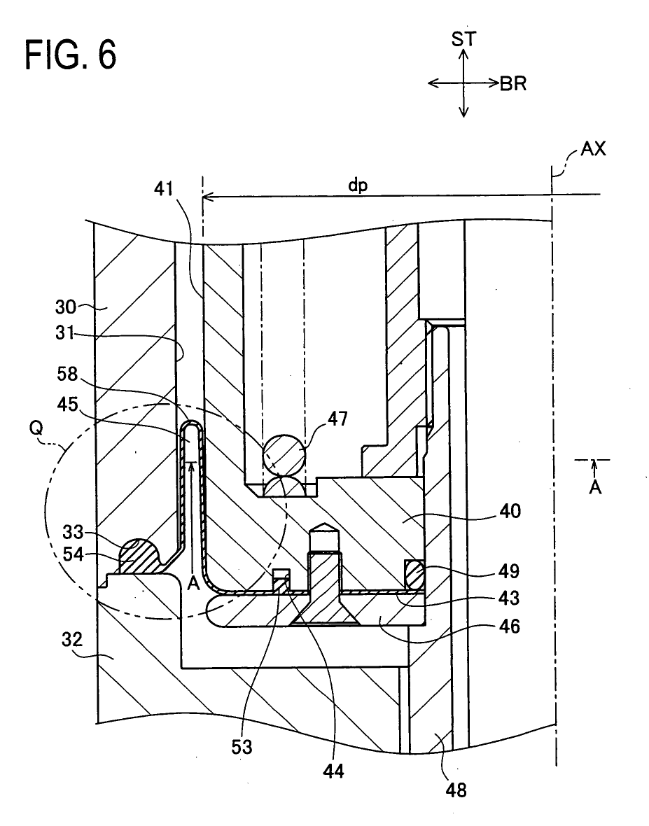

FIG. 1 is an explanatory sectional view of a bellofram 50 arranged in the vacuum opening/closing valve 10 of the present embodiment when seen from a bore direction (a radial direction) BR of a piston 40. FIG. 2 is an explanatory sectional enlarged view of a part X in FIG. 1, showing a rubber molded member 51 constituting the bellofram 50. FIG. 3 is an explanatory view showing a texture of a base cloth 51B of the rubber molded member 51 in FIG. 2. FIG. 4 is an explanatory view showing a structure of the vacuum opening/closing valve 10 in a valve closed state. FIG. 5 is an explanatory view showing a structure of the vacuum opening/closing valve 10 in a valve opened state. FIG. 6 is an enlarged view of a part P shown in FIG. 4.

The vacuum opening/closing valve 10 of the present embodiment is employed for controlling vacuum pressure of a process gas or the like in the vacuum chamber 2 by changing a valve opening degree VL by driving air AR supplied into an air chamber AS through an unshown servo valve from the air supply source 6.

The vacuum opening/closing valve 10 includes a pilot cylinder section 20 and a bellows-type poppet valve section 70. In an axis AX direction, or in a valve shifting direction (a vertical direction in FIGS. 4 and 5) in which a poppet valve element 76 is opened or closed, the pilot cylinder section 20 is located on a valve opening side (an upper side in FIGS. 4 and 5) and the bellows-type poppet valve section 70 is located on a valve closing side (a lower side in FIGS. 4 and 5).

The pilot cylinder section 20 includes a single-acting pneumatic cylinder 30, a flange holding potion 32, the air chamber AS, the piston 40, a return spring 47, the bellofram 50, and others.

In the vacuum opening/closing valve 10, when the driving air AR is supplied to the air chamber AS, the piston 40 is moved upward inside the cylinder 30 in a stroke direction ST in parallel with the axis AX without being in contact with an inner peripheral surface 31 of the cylinder 30. An outer diameter dp of an outer peripheral surface 41 of the piston 40 is designed shorter by a predetermined value than a diameter of the inner peripheral surface 31 of the cylinder 30. The piston 40 includes a pressure receiving surface 43 which is provided with an annular recess 44 recessed in the stroke direction ST. Further, a predetermined clearance 45 is provided between the outer peripheral surface 41 of the piston 40 and the inner peripheral surface 31 of the cylinder 30. As will be described later, the clearance 45 is hermetically sealed by the bellofram 50 in FIG. 1 to ensure the air tightness in the air chamber AS.

In addition, the piston 40 is moved without being in contact with the inner peripheral surface 31 of the cylinder 30, thereby preventing stick-slip of the piston 40. Consequently, the piston 40 can be moved inside the cylinder 30 with high response and accurate positioning.

The piston 40 is urged by the return spring 47 toward the valve closing side in the valve shifting direction. While the driving air AR is not supplied to the air chamber AS, the piston 40 is placed at a bottom dead center by the urging force of the return spring 47 (see FIG. 4). On the contrary, when the driving air AR is supplied to the air chamber AS, the piston 40 is moved toward the valve opening side in the valve shifting direction against the urging force of the return spring 47 (see FIG. 5).

Moreover, in the vacuum opening/closing valve 10, a displacement sensor 81 is provided for measuring a displacement amount of the piston 40 moved from the bottom dead center to a top dead center in the valve shifting direction (see FIGS. 4 and 5). This displacement amount indicates a valve opening degree of the vacuum opening/closing valve 10. The displacement sensor 81 is out of contact with the piston 40 but is electrically connected to the vacuum pressure controller 7.

The bellofram 50 is formed of a rubber molded member 51. The rubber molded member 51 is formed in a manner that a base cloth 51B with a tricot-woven texture is insert-molded with the rubber 51A (see FIGS. 1 and 2). The tricot weave shown in FIG. 3 is, for example, similar to ribbed weave forming a ridge-like pattern having mountain parts and valley parts alternately continuing in a predetermined direction, knitting weave, and the like. Such technique including tricot weave can provide flexible, elastic, and stretchable fabric.

The bellofram 50 is stretchable to keep an effective pressure receiving area of the pressure receiving surface 43 of the piston 40 constant without change when the driving air AR is supplied to the air chamber AS. The bellofram 50 is constituted of the rubber molded member 51 made of the base cloth 51B having enough strength against the pressurizing force of the driving air AR supplied to the air chamber AS and the rubber 51A having enough air tightness. The rubber 51A of the rubber molded member 51 may include natural rubber and synthetic rubber such as acrylonitrile-butadiene rubber, styrene-butadiene rubber, butadiene rubber, isoprene rubber, propylene-butadiene rubber, acrylonitrile-isoprene rubber, chloroprene rubber, isobutylene-isoprene rubber (butyl rubber), ethylene propylene rubber, acrylic rubber, fluorocarbon rubber, ether-thioether rubber, polysulfide rubber, urethane rubber, silicone rubber. As a material for the base cloth 51B, for example, thread such as polyamide (Nylon 6, Nylon 66, or the like), aramid, polyester, or cotton may be selected and woven to be flexible along each surface 51a, 51b of the bellofram 50 (the rubber molded member 51).

As shown in FIG. 1, in the present embodiment, the bellofram 50 is formed with a first tapered surface 55A and a second tapered surface 55B different in inclination angle from each other relative to the axis AX in the stroke direction ST (a vertical direction in FIGS. 4 and 5) of the piston 40 when seen in section from the bore direction BR (a lateral direction in FIGS. 4 and 5) of the piston 40. The bellofram 50 further includes a circumferential flange 54 (a fixing portion) along the peripheral edge in a radial direction (the bore direction BR of the piston 40) and a center portion 52 (a radial center portion) located on the center in the radial direction to be continuous with the flange 54 with the first and second tapered surfaces 55A and 55B interposed therebetween.

The first tapered surface 55A is turned up (in the figure) from the flange 54 at a taper starting point 54S on a radially inner side of the flange 54. The first tapered surface 55A is an annular inclined surface with a first taper angle θ1 (0<θ1<90°) with respect to an imaginary line M parallel with the axis AX. Similarly, the second tapered surface 55B is an annular inclined surface, having a second taper angle θ2 (0<θ2<θ1) with respect to the imaginary line M. The first and second tapered surfaces 55A and 55B are continuous at a curved portion 56. The curved portion 56 is closer to the flange 54 than a center of the bellofram 50 in the axis AX direction in the form shown in FIG. 1. The reason why the curved portion 56 is located in such a position is as follows. The second tapered surface 55B of the bellofram 50 is moved and stretched to the top dead center of the piston 40 in associated with movement of the piston 40 when the vacuum opening/closing valve 10 is closed. At this time, the second tapered surface 55B is mountain-folded near a center position in the stroke direction ST.

Furthermore, the center portion 52 is continuous from the second tapered surface 55B in the bore direction BR of the piston 40 (the lateral direction in FIGS. 4 and 5). The center portion 52 is formed with a through hole 57 through which a piston rod 48 passes and a protrusion 53 circumferentially provided around the through hole 57 and protruding in a thickness direction (the vertical direction in FIG. 1) of the center portion 52. The through hole 57 is accurately shaped in a size to be closely fitted on an outer periphery of the piston rod 48.

As shown in FIG. 6, the protrusion 53 is fitted in the recess 44 of the piston 40, thereby positioning the bellofram 50 with respect to the piston 40. While the center portion 52 of the bellofram 50 is in contact with the pressure receiving surface 43 of the piston 40, the center portion 52 is intervened between the piston 40 and a plate-like fixing member 46, so that the bellofram 50 is fixed by threaded engagement of the piston 40 and the fixing member 46.

Further, the flange 54 of the bellofram 50 is held and firmly fixed between the cylinder 30 and the flange holding portion 32.

In the vacuum opening/closing valve 10, when the piston 40 is at the bottom dead center, more specifically, when the driving air AR is not supplied to the air chamber AS, the flange 54 and the center portion 52 of the bellofram 50 are on almost the same level in the stroke direction ST (see FIG. 4). Concurrently, the second tapered surface 55B is mountain-folded at a top portion 58 in the clearance 45 between the piston 40 and the cylinder 30 as shown in FIGS. 4, 6, and 7.

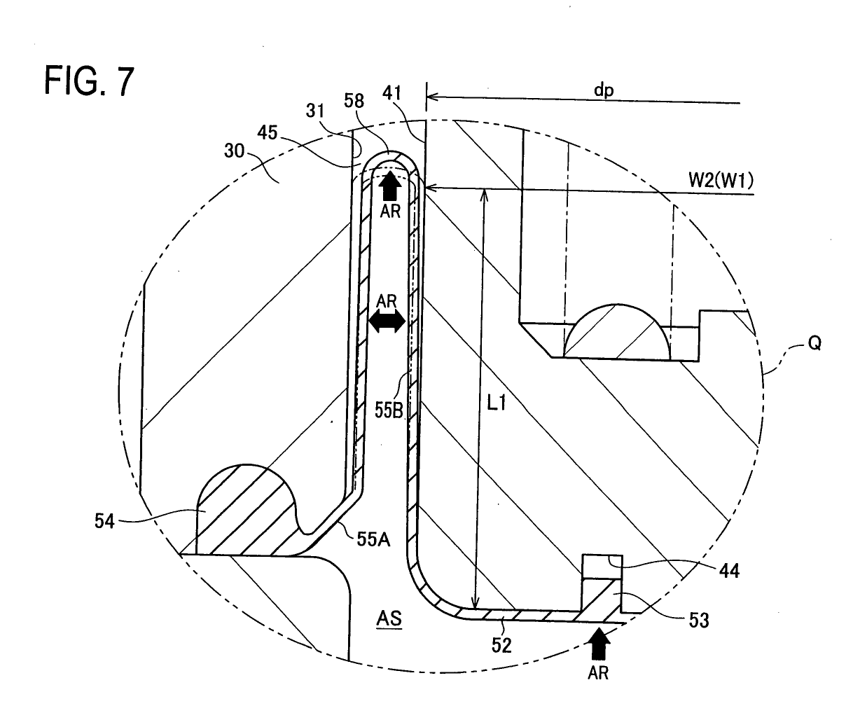

On the other hand, when the driving air AR is supplied to the air chamber AS, the second tapered surface 55B mountain-folded at the top portion 58 as shown in FIGS. 6 and 7 swells out along the inner peripheral surface 31 of the cylinder 30 and the outer peripheral surface 41 of the piston 40 as indicated with a double-dashed line in FIG. 7, and simultaneously stretches out toward the top dead center (an upper side in FIGS. 6 and 7) in the stroke direction ST of the piston 40 as shown in FIG. 5.

As mentioned above, the flange 54 of the bellofram 50 is fixed by the flange holding portion 32 and the center portion 52 of the bellofram 50 is fixed by the pressure receiving surface 43 of the piston 40 respectively. In this state, the first and second tapered surfaces 55A and 55B are placed in the clearance 45 between the piston 40 and the cylinder 30 to hermatically seal the clearance 45 so that the tapered surfaces 55A and 55B be folded in or out in accordance with the movement of the piston 40.

FIG. 6 is an enlarged view of a part P in FIG. 4 in a valve closed state that an O ring 79 is in full contact with a valve seat 73. In other words, FIG. 6 shows the bellofram 50 in the valve closed state.

When the driving air AR is supplied to the valve 10 in the valve closed state that the O ring 79 is in full contact with the valve seat 73, the bellofram 50 changes its shape as indicated with the double-dashed line in FIG. 7. In other words, a contact portion of the bellofram 50 with respect to the piston 40 is slightly changed. In the present embodiment, an inner diameter of the bellofram 50 is defined as W2 at a position where the bellofram 50 is in contact with the piston 40 (specifically, an upper end indicated with a height L or an upper end of the bellofram 50 contacting with the piston 40 as indicated with the double-dashed line in FIG. 7).

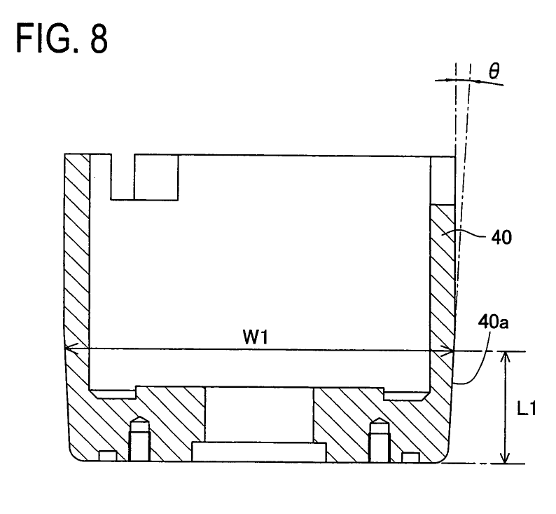

FIG. 8 is a sectional view of the piston 40. The piston 40 includes an end portion having a tapered surface 40a tapered at an angle θ. This angle θ is determined to be equal to the second tapered angle θ2 of the bellofram 50. The piston tapered surface 40a is provided in an about lower half of the piston 40. That is because an upper half will not be in contact with the bellofram 50 and hence does not need to be tapered.

W1 is an outer diameter of an upper contact point of the outer periphery of the piston 40 that contacts with the bellofram 50 when the driving air AR is supplied in the valve closed state that the O ring 97 is in contact with the valve seat 73.

On the other hand, W2 is the inner diameter of an upper contact point of the bellofram 50 that contacts with the piston 40 when the driving air AR is supplied in the valve closed state that the O ring 97 is in contact with the valve seat 73.

As shown in FIG. 7, the outer diameter of the piston 40 at the point at a distance L from a bottom end of the piston 40 is defined as W1. The distance L1 from the bottom end of the piston 40 is as high as the upper contact limit of the bellofram 50 that contacts with the piston 40.

Herein, in the valve closed state shown in FIG. 4, W2 of the bellofram 50 and W1 of the piston 40 are equal in length.

The bellows-type poppet valve section 70 is explained below.

The bellows-type poppet valve section 70 is constituted of a valve main body 71, a bellows 75, the poppet valve element 76, an O ring holder 77, the O ring 79, and others.

The piston rod 48 is arranged to pass through a diametrical center portion of the piston 40 and connected with the piston 40 with an O ring 49 interposed therebetween. The piston rod 48 extends downward to the bellows-type poppet valve section 70 and is connected with the poppet valve element 76 at one end of the piston rod 48 on the valve opening side. The poppet valve element 76 is movable in the valve shifting direction in accordance with the movement of the piston 40 in the stroke direction ST. One end of the bellows 75 (an upper end in FIGS. 4 and 5) in the axis AX direction is fixed to the valve main body 70 or others and the other end of the bellows 75 is fixed to the poppet valve element 76. In this way, the bellows 75 is mounted to surround the radially outer periphery of the piston rod 48 in a stretchable manner in accordance with the movement of the poppet valve element 76 in the valve shifting direction.

The poppet valve element 76 is fixed with the O ring holder 77 on the valve closing side (a lower side in FIGS. 4 and 5) of the poppet valve element 76, thereby forming an annular O ring mounting portion 78 defined by the poppet valve element 76 and the O ring holder 77. The O ring 79 is disposed in the O ring mounting portion 78 to come into contact with the valve seat 73 of the valve main body 71. The valve main body 71 is provided with a first port 72 to be connected to the vacuum pump 5 and a second port 74 to be connected to the gas exhaust port 2b of the vacuum chamber 2.

In the vacuum opening/closing valve 10, while the driving air AR is not supplied to the air chamber AS, the piston 40 is positioned at the bottom dead center by the urging force of the return spring 47. Consequently, the poppet valve element 76 connected with the piston 40 presses against the valve seat 73 through the O ring 79. As a result, the first port 72 is shut off by the poppet valve element 76, thereby closing the vacuum opening/closing valve 10 (the valve opening degree VL=0).

On the other hand, when the driving air AR is supplied to the air chamber AS, the piston 40 is moved to the valve opening side in the valve shifting direction against the urging force of the return spring 47. Accordingly, the poppet valve element 76 is moved to the valve opening side concurrently with the O ring 79, separating from the valve seat 73. Thereby, the vacuum opening/closing valve 10 is opened (the valve opening degree VL>0), allowing the first and second ports 72 and 74 to communicate with each other. After the vacuum opening/closing valve 10 is opened, the vacuum pump 5 is enabled to suck the process gas or the nitrogen gas from the vacuum chamber 2.

In the vacuum opening/closing valve 10 of the present embodiment, the bellofram 50 includes the first tapered surface 55A with the first taper angle θ1 and the second tapered surface 55B with the second taper angle θ2 relative to the axis AX when seen in the bore direction BR of the piston 40 in section.

Now, the first and second taper angles θ1 and θ2 between the imaginary line M parallel with the axis AX and the first and second tapered surfaces 55A and 55B are examined below by comparison between the bellofram 50 of the vacuum opening/closing valve 10 and the bellofram 150 of the conventional vacuum opening/closing valve 100.

As mentioned above, in the vacuum opening/closing valve 10, the angle of the tapered surface 55A with respect to the axis AX (the imaginary line M) is the first taper angle θ1 (0<θ1<90°). Similarly, the angle of the second tapered surface 55B with respect to the axis AX (imaginary line M) is the second taper angle θ2 (0<θ2<θ1). Accordingly, a diameter of the second tapered surface 55B at a certain position along the axis AX direction is defined as a second tapered-surface diameter D2. Further, a circumferential length at this position is defined as a second tapered-surface perimeter πD2.

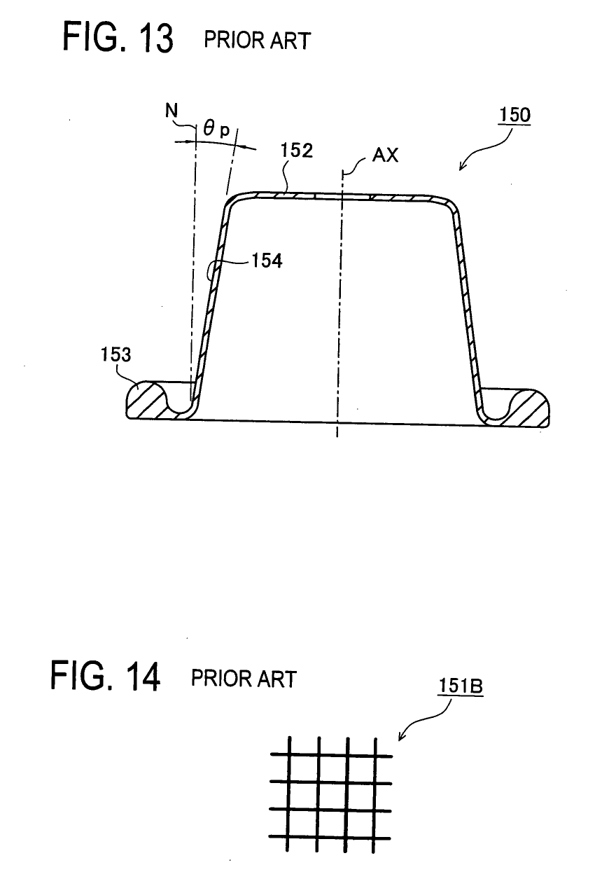

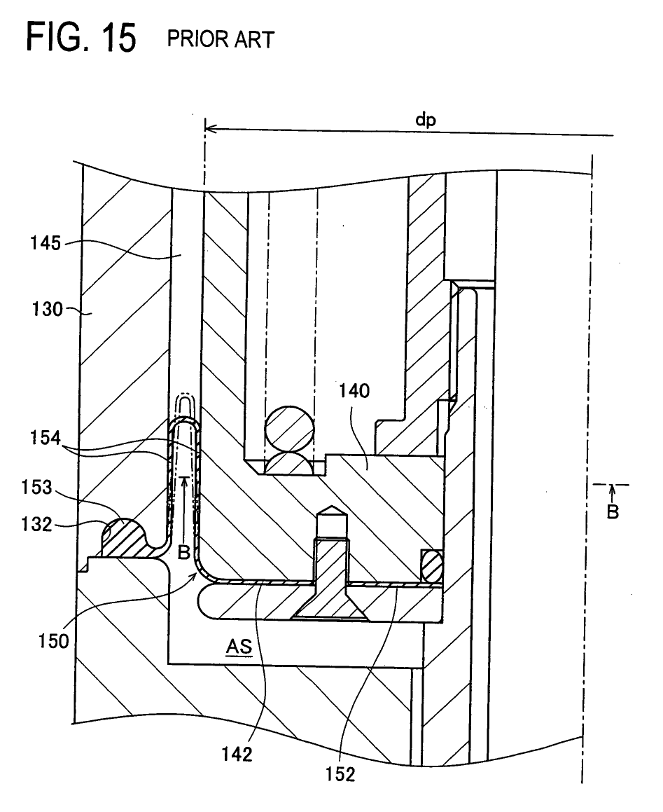

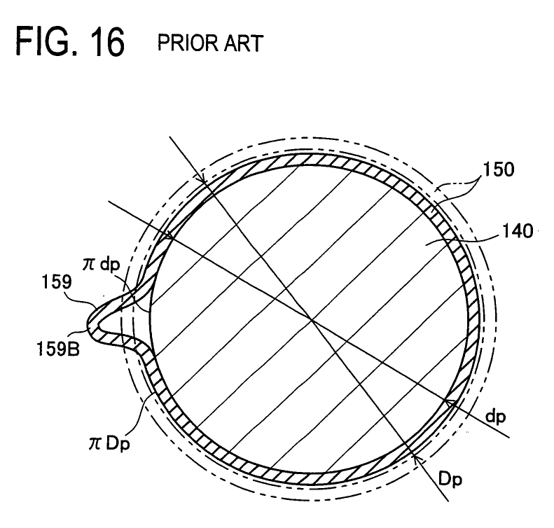

On the other hand, in the conventional vacuum opening/closing valve 100, the bellofram 150 has only the single-tapered surface 154. Specifically, the angle of the single-tapered surface 154 with respect to the imaginary line N parallel with the axis AX of the bellofram 150 is the single-taper angle θp (0<θp<90°) (see FIG. 13). Accordingly, a diameter of the single-tapered surface 154 at a certain position in the piston stroke direction is defined as a single-tapered-surface diameter Dp. Further, a circumferential length at this position is defined as a single-tapered-surface perimeter πDp (see FIG. 16).

In the vacuum opening/closing valve 10 of the present embodiment, the first taper angle θ1 is determined larger than the single-taper angle θp (θp<θ1), hence the second taper angle θ2 can be smaller than the single-taper angle θp (θ2<θp). In other words, the first taper angle θ1, the second taper angle θ2, and the single-taper angle θp are expressed by a relation of θ2<θp<θ1 (1). Based on this relation (1), the bellofram 50 of the vacuum opening/closing valve 10 is designed such that the first tapered surface 55 A with the first taper angle θ1 relative to the axis AX is located closer to the inner peripheral surface 31 of the cylinder 30 and the second tapered surface 55B with the second taper angle θ2 relative to the axis AX is located closer to the outer peripheral surface 41 of the piston 40.

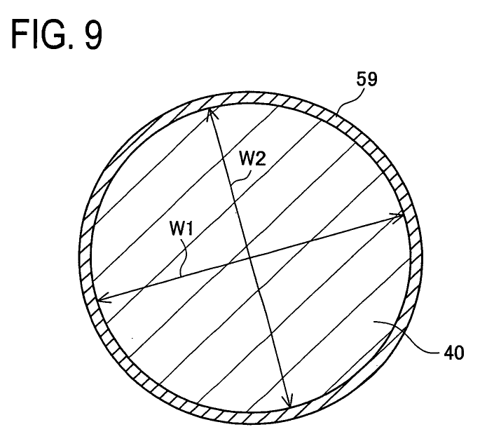

On the other hand, the tapered surface 40a of the piston 40 is angled at the same angle as the second tapered surface 55B of the bellofram 50. When the driving air AR is supplied in the valve closed state that the O ring 79 is in full contact with the valve seat 73, the bellofram 50 becomes deformed or changes its position as indicated with the double-dashed line in FIG. 7. At this time, as mentioned above, at the upper limit where the bellofram 50 and the piston 40 contact with each other, the inner diameter W2 of the bellofram 50 is equal to the outer diameter W1 of the piston 40. Therefore, as shown in FIG. 9, when the driving air AR is supplied, the bellofram 50 and the piston 40 are in close contact with each other, causing no bending or wrinkle at all.

Afterward, the contact position of the bellofram 50 with the piston 40 is changed. However, the tapered surface 40a of the piston 40 has the equal taper angle to the second tapered surface 55B of the bellofram 50 and thus the bellofram 50 and the piston 40 are still continuously held in close contact relation.

Compared to the wrinkled portion 159 generated in the conventional bellofram 150, such wrinkle is never generated in the bellofram 50, so that no stress concentration is caused while the piston 40 is moved. Therefore, cracks in the moving direction of the piston 40 can be prevented even if the piston 40 is moved repeatedly. The applicant of the present application has repeatedly tested and confirmed no cracks generated even though the experiment was repeated several tens times as many as experiments conducted in the conventional valve.

As explained above, according to the present embodiment, the vacuum opening/closing valve is connectable between the vacuum container 2 and the vacuum pump 5 for controlling vacuum pressure in the vacuum container 2 by changing an opening degree of the O ring 79 serving as a valve element relative to the valve seat 73. The vacuum opening/closing valve 10 is also arranged such that a predetermined clearance between the outer peripheral surface of the piston 40 and the inner peripheral surface 31 of the cylinder 30 is hermetically sealed by the bellofram 50 which is moved in accordance with movement of the piston 40 which is moved by fluid to open or close the vacuum opening/closing valve 10. The bellofram 50 is formed at the predetermined taper angle θ2, and the outer periphery of the piston 40 is angled at the predetermined taper angle θ. While the valve element is in contact with the valve seat 73, the inner peripheral diameter of the bellofram 50 contacting with the piston 40 is equal to the outer peripheral diameter of the piston 40. Consequently, in a state that the vacuum opening/closing valve 10 is closed, when the driving air AR is supplied into the cylinder 30 to apply air pressure on the bellofram 50, the bellofram 50 will not be bent or wrinkled since the inner diameter of the bellofram 50 and the outer diameter of the piston 40 are equal.

Conventionally, the piston has a straight cylindrical shape. Therefore, the inner diameter of the bellofram that contacts with the end face of the piston had to be larger than the outer diameter of the piston. In the present embodiment, the outer periphery of the piston includes a tapered surface, so that the inner diameter of the bellofram and the outer diameter of the piston in the valve closed state can be determined to be equal to each other.

Further, the second taper angle θ2 of the inner peripheral surface of the bellofram 50 which is in contact with the piston 40 is equal to the first taper angle θ1 of the piston 40. Therefore, even when the piston 40 is moved by a certain distance, the inner diameter of the bellofram 50 contacting with the piston 40 is equal to the outer diameter of the piston 40 and thus the bellofram 50 is unlikely to be bent or wrinkled.

The applicant has experimentally confirmed that even if the second taper angle θ2 of the bellofram 50 is slightly larger than the taper angle θ of the piston 40, durability of the bellofram 50 can be outstandingly enhanced as long as the inner diameter of the bellofram 50 and the outer diameter of the piston 40 are equal when the O ring 79 as a valve element is in contact with the valve seat 73. The applicant has also experimentally learned that the durability can be further enhanced if the second taper angle θ2 of the bellofram 50 and the taper angle θ of the piston 40 are determined to be equal.

Moreover, the bellofram 50 is formed with the first and second tapered surfaces 55A and 55B, so that the bellofram 50 can be kept stretchable in accordance with opening/closing movement of the vacuum opening/closing valve 10. The bellofram 50 can furthermore be prevented from short-term damages due to cracks resulting from wrinkles of the bellofram 50.

Furthermore, in the vacuum opening/closing valve 10, the curved portion 56 connecting the first and second tapered surfaces 55A and 55B is placed closer to the flange 54 than the center portion of the bellofram 50 along the axis AX direction. Consequently, the second tapered surface 55B of the bellofram 50 will be mountain-folded but not folded at the curved portion 56.

Even when the vacuum opening/closing valve 10 is repeatedly opened and closed, the second tapered surface 55B is not folded at the curved portion 56 at which stress concentration is more likely to occur than at other portions of the first and second tapered surfaces 55A and 55B of the bellofram 50. Therefore, the bellofram 50 can be prevented from deterioration (material fatigue of the rubber molded member 51) caused by repetitive folding of the second tapered surface 55B at the curved portion 56.

As a result, the bellofram 50 can be prevented from any damages at an earlier stage.

In the vacuum opening/closing valve 10 of the present embodiment, the bellofram 50 is fitted on the outer periphery of the piston rod 48 connecting the piston 40 with the poppet valve element 76 holding the O ring 79 as a valve element and also the bellofram 50 is formed with the through hole 57 for positioning the bellofram 50 relative to the piston 40. Consequently, the bellofram 50 can be easily and accurately positioned relative to the piston 40.

In addition, in the vacuum opening/closing valve 10, the bellofram 50 is made of the rubber molded member 51 comprising the rubber 51A and the base cloth 51B which has a tricot-woven texture flexible along the surfaces 51a of the bellofram 50. Specifically, the rubber molded member 51 is formed in a manner that the base cloth 51B is embedded into the rubber 51A by insert molding. As a result, the bellofram 50 can obtain air tightness by the rubber 51A and strength against the pressurizing force of the driving air AR by the base cloth 51B. Concurrently, the bellofram 50 can be bent or change shape freely along the shape of the outer peripheral surface of the piston 40 in association with the movement of the piston 40.

Especially, in the vacuum opening/closing valve 10 of the present embodiment, the base cloth 51B of the bellofram 50 is tricot weave. The bellofram 50 is therefore easy to be bent with aligning itself with the outer peripheral surface 41 of the piston 40 when the second tapered surface 55B of the bellofram 50 swells out along the outer peripheral surface 41 of the piston 40 during the driving air AR supply.

In the vacuum opening/closing valve 10, the bellofram 50 and the piston 40 are coaxially positioned and fixed by fitting the protrusion 53 in the recess 44.

Thereby, the central portion 52 of the bellofram 50 can be prevented from relative misalignment with respect to the pressure receiving surface 43 of the piston 40. Consequently, the first and second tapered surfaces 55A and 55B of the bellofram 50 can be equally bent or extended in a circumferential direction of the tapered surfaces 55A and 55B in association with the movement of the piston 40. As a result, the piston 40 can be moved appropriately, so that the clearance 45 between the outer peripheral surface 41 of the piston 40 and the inner peripheral surface 31 of the single-acting pneumatic cylinder 30 can be hermetically sealed by the bellofram 50 in an appropriate manner.

The present invention is not limited to the above embodiment(s) and may be embodied in other specific forms without departing from the essential characteristics thereof.

For example, in the above embodiment, the recess 44 of the piston 40 is annularly provided in the pressure receiving surface 43 and the protrusion 53 of the bellofram 50 is annularly provided on the center portion 52 respectively. Alternatively, such recess and protrusion may be provided in any other forms as long as they are positioned by engagement. The positions and forms of the recess in the piston and the protrusion in the bellofram may be changed or modified as appropriate.

Further, in the bellofram 50 of the present embodiment, the first annular tapered surface 55A with the first inclination angle θ1 which is defined relative to the imaginary line M is located between the taper starting point 54S and the curved portion 56. Alternatively, a portion of the bellofram between a fixing portion and a tapered surface may be formed in an arc-like shape in section when seen from the bore (or radial) direction.

What is claimed is:

1. A vacuum opening/closing valve connectable between a vacuum container and a vacuum pump, the valve comprising:
a valve seat formed with a port connectable with one of the vacuum container and the vacuum pump;
a valve element movable into and out of contact with the valve seat;
a piston movable by fluid to move the valve element;
a cylinder in which the piston is housed; and
a bellofram placed to hermetically seal a predetermined clearance between an outer peripheral surface of the piston and an inner peripheral surface of the cylinder and to change shape in association with movement of the piston;
the vacuum opening/closing valve being arranged to control vacuum pressure in the vacuum container by changing an opening degree of the valve element with respect to the valve seat,
wherein
the bellofram includes a peripheral surface formed with a predetermined inclination angle and arranged to contact with the outer peripheral surface of the piston,
the outer peripheral surface of the piston includes an inclined surface formed with a predetermined inclination angle,
the bellofram and the piston are designed so that an inner diameter of the peripheral surface of the bellofram at a portion contacting with the piston and an outer diameter of the piston contacting the peripheral surface of the bellofram are equal when the valve element is in contact with the valve seat,
the inclination angle of the bellofram and the inclination angle of the piston are equal,
the peripheral surface of the bellofram comprises first and second inclined surfaces having different inclination angles with respect to an axis along a stroke direction of the piston in section along a central axis of the bellofram, and
the inclination angle of the bellofram is a smaller one of the inclination angles of the first and second inclination surfaces,
the vacuum opening/closing valve further comprising a rod connecting the valve element and the piston,
wherein
the bellofram further includes a through hole through which the rod extends, and
the bellofram is fitted on an outer periphery of the rod through the through hole and positioned in place.

2. The vacuum opening/closing valve according to claim 1, wherein
the bellofram comprises a fixing portion at a radial peripheral edge with which the bellofram is fixed to the cylinder,
the bellofram further comprises a curved portion that connects the first and second inclined surfaces, the curved portion being positioned closer to the fixing portion than a center portion of the bellofram in a direction of the axis.

3. The vacuum opening/closing valve according to claim 1, wherein
the bellofram is made of a rubber molded member formed of a base cloth insert-molded with rubber,
the base cloth is flexible woven texture along a surface of the bellofram.

4. The vacuum opening/closing valve according to claim 3, wherein the texture of the base cloth is tricot weave.
